(19) United States
(12) Patent Application Publication
(10) Pub. No.: US 2007/0157117 A1
(43) Pub. Date: Jul. 5, 2007

(54) Apparatus, method and computer program product providing user interface configurable command placement logic

(75) Inventor: Tomi Viitala, Siivikkala (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/314,782

(22) Filed: Dec. 20, 2005

(51) Int. Cl. G06F 3/048

(52) U.S. Cl. 715/810; 715/811

(57) ABSTRACT

In accordance with but one exemplary embodiment of this invention a computer program is embodied on a tangible computer-readable medium. The execution of the computer program by a data processor of a device results in operations that include operating a command placement manager to map an instance of a user interface (UI) command specification to at least one control of a UI in accordance with information defining a device configuration, where the command specification is comprised of a prioritized list of commands.

This patent application is related in some aspects to commonly assigned U.S. patent application Ser. No. 11/124,651, filed May 9, 2005, entitled: “Method, Apparatus and Computer Program to Provide a Display Screen Button Placement Hint Property”, by Aleksi Uotila, Tuija Lindfors and Auli Joki, which is incorporated by reference herein in its entirety.

### TECHNICAL FIELD

The exemplary and non-limiting embodiments of this invention relate generally to user interfaces and, more specifically, relate to graphical and other types of user interfaces suitable for use in, as a non-limiting example, portable and handheld communication and other types of devices.

### BACKGROUND

An issue that arises during the development of a user interface, in particular a graphical user interface (GUI), relates to the placement of application-drawn (graphical) “Buttons”, i.e., defined screen areas wherein a user may by touching enter data or initiate a command. Some conventional graphical desktop application development environments (e.g., Java™ AWT/Swing/SWT etc.) simply draw a Button where the application defines it. Another UI development environment uses this same concept in the context of a mobile device, such as a cellular telephone, or a personal digital assistant (PDA). However, in the mobile device UI the available screen may not be a touch screen that allows direct activation of a button by clicking it. Also the display screen may be limited in display area such that the usability of an application suffers if the Button is drawn, as area required for the Button subtracts from the total screen area available for the application.

It is known in some mobile devices UIs, such as in cellular telephones, that a UI construct (basically a command to perform some action) can be presented as an operation under a softkey or options menu, as on-screen Buttons are not normally used at least due to the limited available display screen area.

A problem is thus presented in that there are mobile device UI display screens on which it is not practical to draw a graphical Button, due at least to the screen not being touch sensitive and/or the screen area being too limited, without adversely affecting software application usability and portability.

An additional problem arises in that different computers and different mobiles devices typically have a different number of “command places”, where a “command place” is a placeholder for a command in the user interface. Examples of such placeholders can include a soft button, a menu, a button and a voice command. The number of command placeholders can vary between different devices. As a result, it becomes difficult to write user interface software that can be used across multiple different devices, as the software must be adapted to each different device. Further, it can become difficult or impossible to write user interface software even for a single device, as the number of placeholders may change in a future evolution of the device.

### SUMMARY

In accordance with exemplary embodiments of this invention a computer program is embodied on a tangible computer-readable medium the execution of which by a data processor of a device results in operations comprising operating a command placement manager to map an instance of a user interface (UI) command specification to at least one control of a UI in accordance with information defining a device configuration, where the command specification is comprised of a prioritized list of commands.

Further in accordance with exemplary embodiments of this invention a device includes a user UI comprised of a display and a user input comprised of at least one control, a data processor for running at least one application, and a UI command placement manager responsive to an instance of a UI command specification, comprised of a prioritized list of commands, to assign the at least one control to a command in accordance with information defining a device configuration.

Further still in accordance with exemplary embodiments of this invention a method to operate a UI includes providing a UI-related prioritized command specification that is associated with an application and, when the application is executed, mapping individual UI commands from the command specification to UI resources based on at least information conveyed by the commands, a context that is descriptive of a UI state of the application, and on information describing a configuration of a device that comprises the UI.

In accordance with still further exemplary embodiments of this invention a UI manager comprising means, responsive to a prioritized command specification that is associated with an application, for mapping individual UI commands from the command specification to UI resources based on at least information conveyed by the commands, a context descriptive of a UI state of the application, and on information describing a configuration of a device that comprises the UI, where a command comprises command properties comprised of at least an ID property that uniquely identifies the command and a Type property that is descriptive of an intent of the command.

### BRIEF DESCRIPTION OF THE DRAWINGS

In the attached Drawing Figures:

FIG. 1 is a high level conceptual view of a UI development environment and a mobile device having a UI to be developed;

FIG. 2 is a logic flow diagram of a method for operating with the UI development environment of FIG. 1;

FIG. 3 is a block diagram that is useful in explaining the concept of an enhanced button area;

FIG. 4 is a block diagram that is useful in describing in greater detail the enhanced button group concept and design;

FIG. 5 is a block diagram that illustrates the command placement manager and associated logical and other units in accordance with the exemplary embodiments of this invention; and

FIG. 6 shows a simplified block diagram of an electronic device suitable for use in practicing the exemplary embodiments of this invention.

### DETAILED DESCRIPTION

By way of introduction, the use of the exemplary embodiments of this invention enables a software application to define a list of commands (comprising a placement hint and command type information) in a priority order. This list may be referred to as a placement list. A device defines an associated “command UI” properties and a placement rule list, which define command place holder priorities and a preferred command type for each place holder for each command UI. Based on these definitions an algorithm places the commands on the available UI. Configuration and reconfiguration may be performed by changing the command UI configurations and/or the placement rule lists.

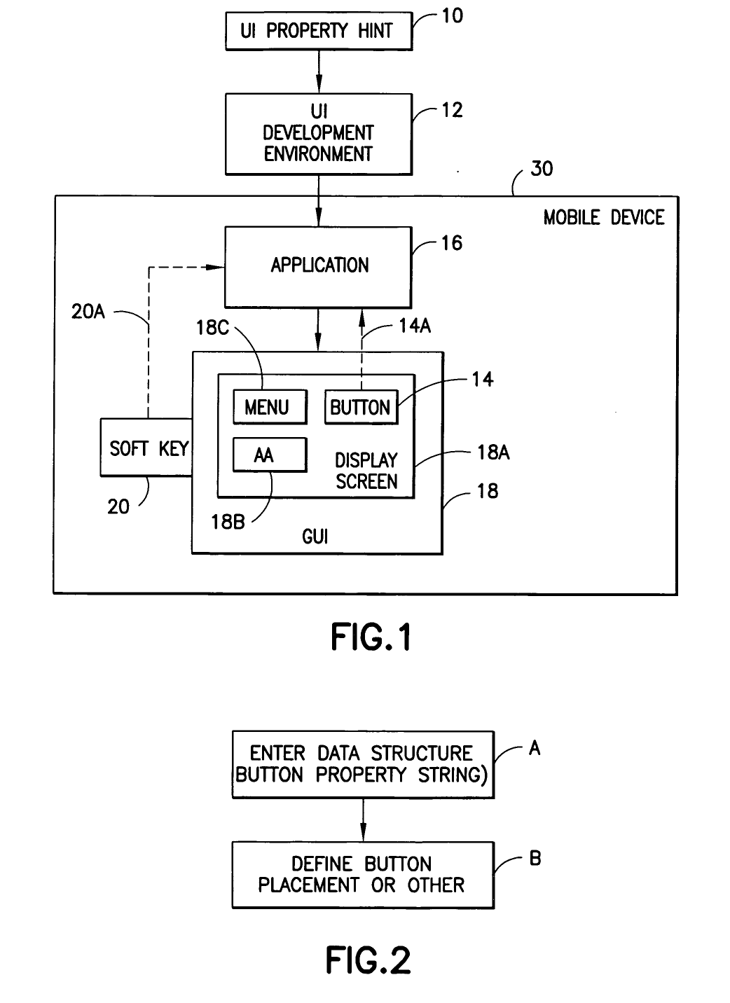

Further by way of introduction, reference can be had to FIG. 1 which is found in the above-referenced commonly assigned U.S. patent application Ser. No. 11/124,651. The embodiments of the invention described in the above-referenced commonly assigned U.S. patent application Ser. No. 11/124,651 provide a UI property hint 10 that an underlying UI development environment 12 may employ to determine whether a Button 14 should be drawn, as it is defined by an application 16 for its graphical user interface (GUI) 18, if the available device UI screen 18A is a touch screen (or otherwise suitable for use with the Button 14), or whether the Button 14 should instead be placed under a device softkey 20 as a command if the available device UI screen 18A is not a touch screen (or otherwise impractical, such as due to limited viewing area), and a softkey 20 is available. Whether the Button 14 or the softkey 20 are used, activating either results in an output 14A, 20A that is detectable by the application 16, and which may then take some defined action in response thereto. The application 16 and GUI 18 are assumed to be embodied during use in a mobile device 30. The screen 18A may also be considered to include an application area (AA) 18B, and possibly a displayable menu 18C.

The UI property hint 10 may also be employed to force the underlying UI development environment 12 to always draw the Button 14, even if the device UI screen 18A is not a touch screen (or otherwise impractical). In addition, the UI property hint 10 may also be employed to force the underlying UI development environment 12 to always define the Button 14 with a touch screen 18A softkey 20, assuming that a softkey 20 is available in which the Button 14 may be added as a command.

In an exemplary embodiment the UI property hint 10 may be implemented as a property string, or with any other suitable data object, that can be read by the underlying UI development environment 12 and preferably manipulated by an application developer. It is noted that in many UI Application Program Interfaces (APIs) there is generic mechanism present to set properties to UI components. The actual implementation of the UI property hint 10 is dependent on the property mechanism of a development GUI toolkit.

As a non-limiting example, the UI property hint 10, when implemented as a property string, may have the form: “component-displacement-hint”, with values such as “softkeys” and “on-screen”. This property string is treated as a “hint”, and the “displacement” is used only if it makes sense in the actual implementation. For example, if there is no softkey 20, and the softkey displacement hint is used in the property string, then it is ignored.

More specifically, there is defined a property name/value pair. The property name may be, for example, “component-displacement”, and suitable values may be, as non-limiting examples, “default”, which places the component (Button 14) to, for example, a softkey 20 or to a menu in a non-touch screen 18A, or that presents the Button 14 in an application area 18B on a touch display screen 18A. A value of “softkey” explicitly states that the component should be placed to the softkey 20. A value of “menu” explicitly states that the component should be placed to, i.e., should form an element of, a menu 18C. A value of “app_area” explicitly states that the component should be in the application's 16 client area 18B on the display screen 18A, where it is positioned by application 16. This latter value may be considered to be equivalent to a null/no-value “component-displacement” property.

It is pointed out that how these property values are actually used depends on the UI API in question, but often there is provided a construct similar to a setProperty(String name, String value) method in a generic component class.

It is also pointed out that while the UI API may have a construct similar to setProperty(String name, String value) as described, in other non-limiting embodiments the property may be set manually (i.e., not through the UI API) in a property file, and it is then read by a corresponding UI library implementation (such as a Java™ eSWT/AWT/Swing) at system startup.

One suitable and non-limiting GUI toolkit for use in the UI development environment 12 is one known as eSWT (under development), also known as Embedded SWT, that is based on a Standard Widget Toolkit (SWT) available from Eclipse Foundation (http://www.eclipse.org). As is presently specified in Section 1.4.4, Layout Management, in a document entitled: eSWT Requirements and High-Level Architecture (Sep. 25, 2004), a Composite class is one that holds one or more UI components. Composite has a Layout object responsible for laying out contained components. If no layout is set by the application (layout is null) then the components can be sized and positioned within the composite by their absolute coordinates relative to the composite origin. In Section 1.4.7, Widgets, a Button is defined as allowing user interaction such as pressing and releasing. Three Button styles are currently defined: PUSH (normal button), CHECK (on/off states) and RADIO (on/off depending on other RadioBoxes in the same RadioBox group).

Note, however, that eSWT does not have currently have a method setProperty(String name, String value) in its Composite class.

Note further that a property method in eSWT/SWT Component, referred to as setData( ), has the form:

public void setData(java.lang.Object data)

public void setData(java.lang.String key, java.lang.Object value)

In the non-limiting example of the eSWT UI development environment 12 the UI property hint 10 (Button 14) placement hint aids the application developer in giving information (a hint) to the underlying UI development environment 12 to determine where and when a Button 14 is placed in different mobile device screens (e.g., draw in the screen 18A or place under a softkey 20), and thus improves usability and portability of applications between different mobile devices having different display screen 18A and softkey 20 characteristics.

Referring to FIG. 2, and in view of the foregoing description, it can be appreciated that the above-referenced commonly assigned U.S. patent application Ser. No. 11/124,651, in one aspect thereof, provides a method to develop a graphical user interface that includes (Block A) entering a data structure 10 that specifies a preferred form of a Button 14 to appear on a display screen 18A, and in response to the data structure, (Block B) defining at least one of a displayable Button placement for a specific instance of a display screen 18A, or the use of another user input mechanism, such as the softkey 20, in place of a displayable Button for the specific instance of the display screen 18A.

Having thus described the exemplary embodiments of the invention that are presented in the above-referenced commonly assigned U.S. patent application Ser. No. 11/124,651, a description of the exemplary embodiments of this invention is now provided.

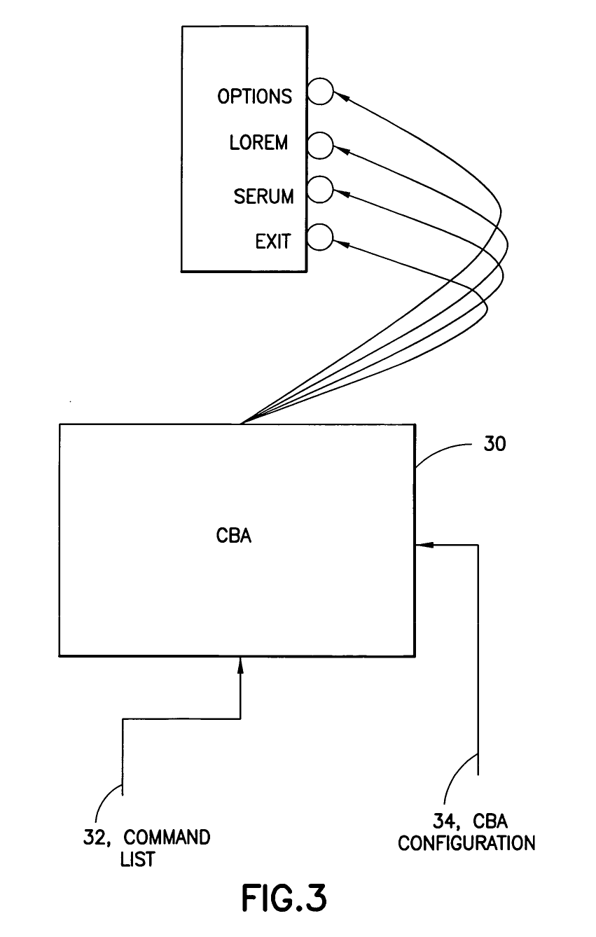

The following abbreviations and terms that are referenced in the ensuing description are defined as follows. The reference numbers correspond to those found in FIGS. 3, 4 and 5, as discussed in further detail below.

CBA 30

Command Button Area

Context 56

The UI state of an application 16. The application 16 defines the available commands to a command placement manager 50 by setting the context. Context 56 is always related to a Supercontext 70.

Command Place

Command place is a place (location) within a command UI where a command can be placed.

Command Placement Manager 50

An implementation providing for full command placement abstraction, where command placement is abstracted between command UIs and within command UIs.

Command Specification 52

An application 16 configures the command placement manager 50 with a command specification 52. The command specification 52 defines, for example, commands 42, a command structure 54, a context 56 and a placement list 58.

Command Structure 54

The command structure 54 defines the hierarchy of the commands 42. A modified command structure is one that is modified from some other command structure by adding, replacing or removing commands.

Command Type

The command type defines the basic nature of a command 42. There are a plurality of predefined command types that are used when placing commands.

Command UI 60

The command UI 60 presents commands to a user. For example, a menu 62, the CBA 30 and a toolbar 46 are each a command UI. In general, the command UI represents at least one of soft controls (e.g., soft or virtual buttons, such as those displayed to a user on a touch sensitive display screen) and physical controls, such as a physical key or button having a fixed or a variable and assignable functionality. Voice input may be considered for the purposes of this description to represent a physical control, as can other types of inputs derived from a sensor or sensors (e.g., acoustic sensors, optical sensors, motion sensors and so forth).

Device Configuration 34

The device configuration 34 configures the available Command UIs 60 and placement policies between command UIs and within a command UI.

Enhanced Button Group

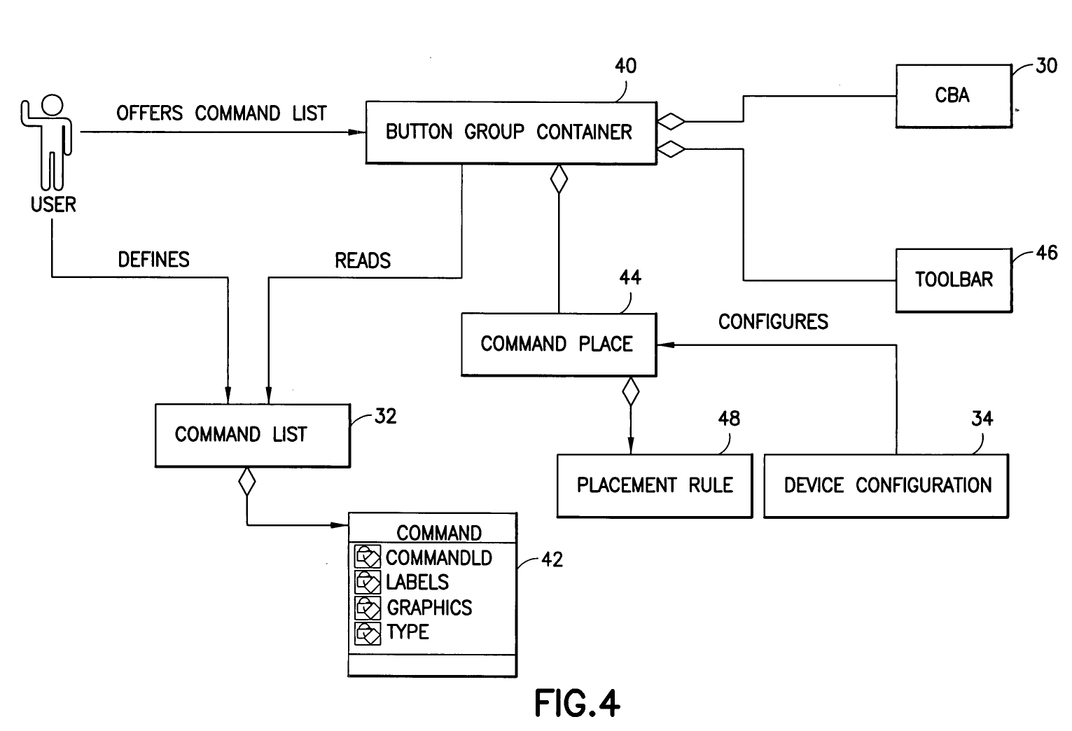

An implementation for full partial placement abstraction, where command placement is abstracted within command UIs but not between command UIs (see the description of FIGS. 3 and 4 below).

Full Command Placement Abstraction

A concept where command placement is abstracted between command UIs and within command UIs. An implementation of the full command placement abstraction is referred to herein as command placement management, and is a function of the command placement manager 50.

Partial Command Placement Abstraction

A concept where command placement is abstracted within command UIs but not between command UIs. An implementation of the full command placement abstraction is referred to as the above-defined Enhanced button group.

Placement Hint 76

A hint defined in the command specification 52 that proposes the placement for a command.

Placement List 58

The placement list 58 contains the placement hints 76 in priority order. The placement list 58 is defined in the command specification 52.

Placement Rule 48

The placement rule 48 defines the preferred command for the command place. For example, “preferred command” is “Open”. Placement rules 48 are defined in the device configuration 34.

Soft Button Collection 64

The soft button collection 64 is a UI element type that contains soft buttons. For example, CBA 30 is a soft button collection. A soft button may be associated with a physical button or control, where the function executed by activating the button can be changed, as opposed to a hard button that has at least one pre-defined and fixed function (e.g., a select function).

Supercontext 70

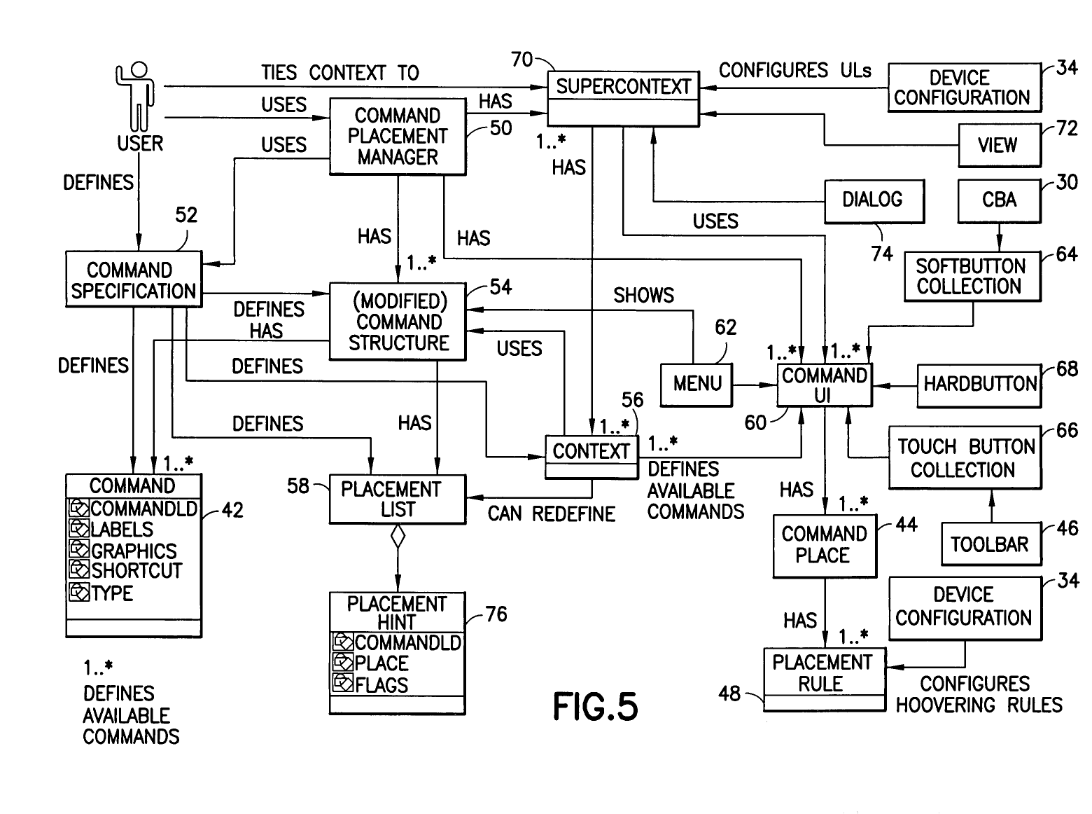

The supercontext 70 defines the UI entity and its command UIs where commands are available. For example, both view 72 and dialog 74 are supercontexts 70. A context 56 is related to some supercontext 70 and, in general, a software state is related to a view 72 or a dialog 74. Available command UIs 60 and the placement policy between command UIs are defined for each supercontext 70 in the device configuration 34 (see FIG. 5 and the description thereof).

Toolbar 46

The toolbar 46 is a collection of graphical touch buttons.

Touch Button Collection 66

The touch button collections 66 is a UI element type that contains graphical touch buttons. For example, the toolbar 46 may be considered to be a touch button collection.

Command placement management, which provides for true UI scalability, enables the provisioning of a number of useful features. As one non-limiting example, command placement management in accordance with the exemplary embodiments of this invention enables the use of the partial command placement abstraction for an application 16. In partial command placement abstraction locations are abstracted within a single command UI 60, such as CBA 30 or the toolbar 46, but command placement is not abstracted between command UIs 60. For example, in CBA 30 this implies support for a variable number of soft buttons 64 such that the application 16 need not have knowledge of the exact number of soft buttons in a given device. The implementation of partial command placement management may be referred to as the enhanced button group.

As another non-limiting example, command placement management in accordance with the exemplary embodiments of this invention enables the use of the full command placement abstraction for an application 16. In the full command placement abstraction the placing of commands is abstracted between command UIs 60, unlike in the partial command placement abstraction.

Note that the command placement manager 50 makes it possible for an application 16 to make use of command UI elements that may not be known to the developer of the application 16. The basic principle is that the application designer defines the operations (commands 42) that are available in each context 56. In so doing a sufficient number of properties are specified for the commands 42 so that system software, such as the operating system (OS) as enhanced by the exemplary embodiments of this invention, can execute the mapping and assignment of commands to appropriate UI locations in a reasonable order.

As a further non-limiting example, command placement management in accordance with the exemplary embodiments of this invention enables the use of device-specific and application-specific command placement and command UI 60 customization.

Referring to FIG. 3 with regard to an enhanced button area, the CBA 30 takes as input the command list 32 and the CBA (device) configuration 34. The enhanced button group may be considered to be an API extension to an existing button group. In the enhanced button group an application 16 can provide in the command list 32 those commands that are eligible to be placed to a particular button group. The CBA 30 determines according to the configuration 34 data which command(s) 42 are attached to UI soft keys. The application 16 may also query, via the API, whether a given command has been associated with a soft key.

FIG. 4 is an illustration that is useful in describing in greater detail the enhanced button group concept and design. In this example a user defines the command list 32 and offers same to a button group container 40. A given command 42 may include, as non-limiting examples and as is described in greater detail below, various properties such as a Command ID, a Label or Labels, Graphics and a Type. The button group container 40 is interfaced to the command list 32 for reading a command or commands there from, to a command placement or place 44, to a toolbar 46 and to the CBA 30. The device configuration 34 outputs device-specific configuration information to the command placement 44, which operates in accordance with the list of placement rules 48. These various operations and units are described in even further detail below with regards to FIG. 5.

Described now are commands 42 in the context of command properties and command types.

In the context of the exemplary embodiments of this invention each command 42 may contain the following properties (note that the inclusion of one or more of these properties may be considered as being optional).

ID

The ID property provides a unique reference to the command 42.

Type

The Type property describes the intent of the command and aids the command manager in presenting the command it in an appropriate manner (discussed in further detail below).

Labels

The Labels property describes the command name or names to be displayed, and may contain different length versions of the name for different uses. The first name provided is assumed to be the default name of the command 42. There may be a default label for all regular command types, and thus this field may be empty for such commands. Any number of labels may be stored into the label property field, e.g., as a list or table. The host system or device selects at runtime the one label that is best accommodated within the available display space.

Sub-labels (Optional)

Sub-labels provide another version of the command name, to be used when the command 42 is placed in a group that has a title (such as a submenu).

Graphic (Optional)

In the event that a command 42 can be represented as an icon, this field holds the graphical representation(s) such as, but not limited to, monochrome, color, bitmaps and vector-based. The Graphic property may be used in, for example, Toolbars.

Shortcut (Optional)

The Shortcut defines a way for the user to initiate the command by a shortcut, such as by typing “Ctrl-K”.

Described now are various command Types. The command Types are predefined properties that can be assigned to commands. The Command Placement Manager 50 (see FIG. 5) uses this information in order to find an appropriate representation and location for individual ones of the commands 42. The regular command Types may include the following.

OK

This command Type indicates a command 42 to provide a standard positive answer. This is a hint that the command 42 is used to confirm data or selection and to proceed to a next logical screen. This type of command 42 may be mapped to a Select key on the device UI.

OPEN ITEM

This command Type indicates a command 42 to open a selected item. This is a hint that the command 42 is used for opening a currently selected item for editing or viewing.

DELETE ITEM

This command Type indicates a command 42 to remove or destroy data. This is a hint to map the associated command 42 into a (soft) key that a style guide recommends to be used for such operations.

OPERATE ITEM

This command Type indicates a command 42 to operate a selected item. This is a hint that the associated command 42 is used for performing some operation on a selected item.

CREATE ITEM

This command Type indicates a command 42 to create an item. This is a hint that the command 42 is used for adding some new item to the display. As one non-limiting example, this command Type can be associated with a command 42 for adding a contact to a device phonebook (contact list).

CANCEL

This command Type indicates a command 42 to provide a standard negative answer. This command type can also hint that the user desires to dismiss the screen without taking any action.

BACK

This command Type indicates a navigation command 42 to return the user to a logically previous screen.

EXIT

This command Type indicates a command 42 to exit an associated application 16.

STOP

This command Type indicates a command 42 to stop a currently running process or operation.

HELP

This command Type indicates a command 42 to request on-line help.

ANY COMMAND

This command Type indicates a command 42 having an undefined command type.

In a typical (but non-limiting) implementation there would be one simultaneously available command 42 of each of the Types OK, CANCEL, BACK, and EXIT. Other of the command Types may be used for several simultaneously available mutually different commands 42.

Referring to FIG. 5, the command placement manager 50 is shown in a technological context (those components shown also in FIGS. 3 and 4 are numbered accordingly). A command specification 52 is defined, or otherwise provided by an application 16 (shown generically as a user). The command specification 52 defines the commands 42, the command structure 54, command contexts 56 and command placement 58.

FIG. 5 also shows command UIs 60. The command UI 60 is a UI element that presents commands 42 to the user. For example, there may be the following exemplary command UIs 60 in a particular device.

Menu 62

The menu 62 may be assumed to be present in all device instances, and to contain all the commands in the given state.

Softkeys 64

The soft keys 64, also referred to as a soft button collection or set) are associated with the above-described CBA 30. There may be a minimum of two soft keys with labels.

Toolbar 46

The toolbar 46 is a graphical UI element on the display screen that may contain touch sensitive buttons (touch button collection 66) or other elements.

There may also be one or more “hard” buttons 68, such as physical keys, buttons or other controls having pre-defined functionality. One example is a Select key that may be located in the immediate neighborhood of, or integrated into, the display UI navigation hardware. A Select or Open command may be associated with the Select key, or activating it may bring up an “OK Options menu” that contains one or more of the most important functions available in the current state of the application 16. Another example is an Enter key of the type available in a standard qwerty keyboard. The Enter key may duplicate the functionality associated with the Select key. However, in certain cases the Enter key operates differently, such as in a text editor where it produces a linefeed character.

In addition to the foregoing controls gestures may be employed, for example, those based on some specific pen or stylus movement on a touch screen. Another example is a voice commands, assuming that the device includes at least rudimentary voice recognition capability. Special purpose hardware buttons may also be available in some device configurations, such as a specific volume controller button or roller. Other elements may also be available, including device-specific elements (such as one or more that sense movement, acceleration and/or an orientation of the device in three dimensional space).

In view of the foregoing it can be appreciated that the command placement manager 50 configuration may also be device-specific so that it can present the commands in appropriate ways for a particular device. The logic of command presentation may further be dependent on a current context, including such events as pen or stylus usage on a touch-sensitive display.

In general, not all UI elements may be available at all times. For example, during a dialog the Toolbar 46 may not be available. Therefore, the available UI elements may be defined for each UI supercontext 70, and the command placement manager 50 is thus made aware of the UI supercontext 70. Inputs to the supercontext 70, in addition to the contexts 56 and device configuration 34, may include information related to a current UI screen view 72, and/or information related to the presence of absence of an ongoing dialog 74 (both of which may be considered to be supercontexts). In general, the supercontext 70 defines the UI entity to which command UIs are related. The supercontext 70 may be, as non-limiting examples, the view 72 or the dialog 74. The supercontext 70 is useful, as views and dialogs may have a different set of available command UIs. Every context 56 is related to a supercontext 70. The context 56 is related to the UI state of an application 16, and the application 16 uses the command placement manager 50 by setting the context 56. In general, the context 56 defines the available commands 42, the command structure 54 and the placement list 58. The command structure 54 defines the placement list 58, which is used if the context 56 does not overwrite (redefine) it.

A UI style guide defines guidelines on what kind of commands should be mapped with specific softkeys, in what order the commands should be placed in an Options menu, and so on. The command placement manager 50 follows the guidelines defined by the UI style guide. To accomplish this, the command placement manager 50 uses information concerning the commands 42, and this information is available in the command structure properties as defined below.

The command specification 52 may define one or more command structures 54, where the command structure 54 defines a hierarchy of the commands 42. The following is an example of a command structure 54,

File

Open

New

Send
As SMS
AS MMS

Move

as is:

Edit

Copy

Cut

Paste

The command structure 54 may define both two level command hierarchies and more than two level hierarchies (optional). The command placement manager 50 device configuration may choose to prefer one of two level or more than two level hierarchy definitions. If a preferred hierarchy is not defined, then the menu 62 may be capable of using both. The command structure 54 may also have the placement list 58 defined for a given command hierarchy.

The modified command structure 54 is based on some other (base) command structure. It has a same hierarchy as the base command structure, but it may have additional commands added, or it may disable use of one or more commands. The modified command structure 54 may also overwrite (supercede) the placement list 58.

In general, the command placement manager 50 avoids the potential problem related to attempting to automate the creation of a menu hierarchy, as this would require creating a large set of predefined global commands and command hierarchy templates for a given system. Instead, the command placement manager 50 enables an application 16 to define a menu hierarchy. The command placement manager 50 preferably assumes, but not as a limitation upon this invention, that there exists a Menu UI that is capable of presenting a full menu hierarchy to a user.

Further, by the use of the command placement manager 50 the commands 42 can be moved or copied from a menu UI to other command UIs based on the placement list 58. In addition, the command placement manager 50 can make use of the command specification 52 that defines the commands 42 are used in some application 16s.

As was discussed above, the command placement manager 50 operates in conjunction with the device configuration 34. In general, the device configuration 34 defines available Command UIs 60 in different supercontexts 70, defines the priority between different command UIs, and facilitates use of a removal or co-existence policy of commands 42 between different command UIs. The command UI 60 device configuration indicates a number of commands 42 and a primary input style of a command UI. Examples of primary input styles include, but are not limited to, soft buttons, touch and voice. The command UI 60 can also indicate a maximum number of hierarchy levels supported by the command UI, and can aid in removing disabled commands (On/Off). The command UI 60 may also facilitate the placement rules list 48, where the placement rule list 48 contains the command types in priority order. An example of one such placement rule list 48 is:

1. OPEN ITEM

2. CREATE ITEM

3. OPERATE ITEM

4. ANY COMMAND

There is a placement list 58 related to every context 56. The placement list 58 contains the placement hints 76 that are handled one by one from the start of list. The order of the placement list 58 defines the placement priority of commands 42. Each placement hint 76 has at least the following information: the Command ID, which defines the command to be placed, and the actual placement hints in priority order, e.g., soft buttons, touch element, voice command, hard button(s). Each placement hint 76 may optionally contain other options, such as remove from a menu if placed, and/or duplicate if placed earlier.

The commands are placed on the UI by the command placement manager 50 according to the placement list 58 priority. However, the placement rule list 48 configured in the device configuration 34 for the command UI has a higher priority than the placement list 58. This implies that, for example, the last command in the placement list 58 priority may be placed on the UI if some command UI has prioritized it as a high priority command.

The command placement manager 50 may be customized by replacing the command UIs 60 with a different implementation, and/or by changing the device configuration 34, which can alter the number of available command UIs 60 in each supercontext 70 and command placement policy 44.

In some embodiments of this invention it may be possible to customize command specifications in a centralized manner, such as by providing support for: “Add this command to all menus”, or “Change command specification 52 for this application”.

With regard to the command placement logic of the command placement manager 50, it is within the scope of the exemplary embodiments of this invention to also provide logical command placement options, such as:

IF (cmd X is in SOFTKEY) THEN (cmd X is not in MENU).

It is also within the scope of the exemplary embodiments of this invention to provide user dialogs 74 with a command placement manager 50 logic that is modified for accommodating this type of UI interaction with the user, as well as to provide for application-specific command UIs 60.

It is also within the scope of the exemplary embodiments of this invention to provide localized Labels for some standard commands (e.g., OK, Back, Exit) could are available as global Labels so that each application 16 need not provide them, as well as to provide for the use of some global commands that a certain application 16 may wish to be available everywhere, such as within the options of other applications.

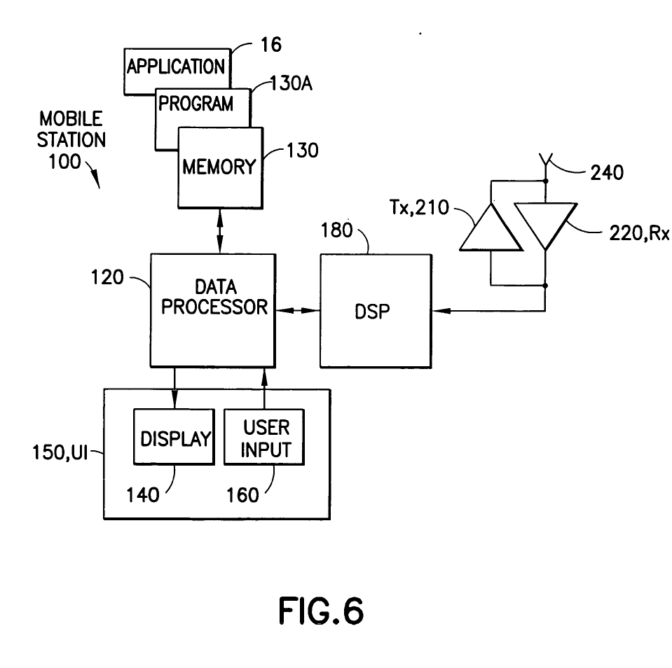

Reference is made to FIG. 6 for illustrating a simplified block diagram of one exemplary electronic device that is suitable for use in practicing the exemplary embodiments of this invention. In FIG. 6 the device is depicted as a mobile station (MS) 100, such as a cellular telephone. The MS 100 includes a data processor (DP) 120 and a memory 130 that stores at least one application 16 and a program 130A. The MS 100 may also include a suitable radio frequency (RF) transceiver 210, 220 for bi-directional wireless communications with a wireless network via an antenna 240. The transceiver may be coupled to the data processor via a digital signal processor (DSP) or some other high speed signal processing logic. Coupled to the data processor 120 is a UI 150 that includes a display 140 and a user input 160, such as one having one or more keys, buttons, voice recognizers, etc., which may be referred to generically as “controls”. If the display 140 is touch sensitive then the functionality of the user input 160 may be implemented in whole or in part by display 140.

The program 130A is assumed to include program instructions that, when executed by the associated data processor 120, enable the device to operate in accordance with the exemplary embodiments of this invention, as were discussed above.

In general, the various embodiments of the MS 100 can include, but are not limited to, cellular telephones, personal digital assistants (PDAs), portable computers, image capture devices such as digital cameras, gaming devices, music storage and playback appliances, Internet appliances permitting wired or wireless Internet access and browsing, as well as portable units or terminals that incorporate combinations of such functions. Devices that do not have wireless capabilities can benefit from the use of the exemplary embodiments of this invention, as can wireless communications enabled devices (including both radio frequency and optical (e.g., IR)-enabled devices.

The embodiments of this invention may be implemented by computer software executable by the DP 120 of the MS 100 and/or other DPs, or by hardware circuitry, or by a combination of software and hardware.

The memory 130 may be of any type suitable to the local technical environment and may be implemented using any suitable data storage technology, such as semiconductor-based memory devices, magnetic memory devices and systems, optical memory devices and systems, fixed memory and removable memory. The DP 120 may be of any type suitable to the local technical environment, and may include one or more of general purpose computers, special purpose computers, microprocessors, digital signal processors (DSPs) and processors based on a multi-core processor architecture, as non-limiting examples. Based on the foregoing it should be apparent that the exemplary embodiments of this invention provide a method, apparatus and computer program product(s) to operate the UI 150 by providing a UI-related prioritized command specification that is associated with an application and, when the application is executed, mapping individual UI commands from the command specification to UI resources based on at least information conveyed by the commands, a context descriptive of a UI state of the application, and on information describing a configuration of a device that comprises the UI.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A computer program embodied on a tangible computer-readable medium the execution of which by a data processor of a device results in operations comprising operating a command placement manager to map an instance of a user interface (UI) command specification to at least one control of a UI in accordance with information defining a device configuration, where the command specification is comprised of a prioritized list of commands.

2. The computer program as in claim 1, where the command specification defines commands, a command structure, command contexts and command placement.

3. The computer program as in claim 1, where a command comprises command properties.

4. The computer program as in claim 3, where the command property is comprised of an ID property that uniquely identifies the command.

5. The computer program as in claim 3, where the command property is comprised of a Type property that is descriptive of an intent of the command.

6. The computer program as in claim 3, where the command property is comprised of a Labels property that is descriptive of at least one command to be displayed.

7. The computer program as in claim 6, where the command property is comprised of a Sub-labels property that is descriptive of another version of the command name used by the command placement manager when the command is placed in a group that has a title.

8. The computer program as in claim 3, where the command property is comprised of a Graphics property that is descriptive of a graphical representation of the command.

9. The computer program as in claim 3, where the command property is comprised of a Shortcut property that defines a mechanism for a user to initiate the command by a shortcut.

10. The computer program as in claim 5, where the command Type is comprised of a Type that specifies that the command is used to provide a positive response.

11. The computer program as in claim 5, where the command Type is comprised of a Type that specifies that the command is used to provide a negative response.

12. The computer program as in claim 5, where the command Type is comprised of a Type that specifies that the command is used for opening a selected item.

13. The computer program as in claim 5, where the command Type is comprised of a Type that specifies that the command is used to destroy data.

14. The computer program as in claim 5, where the command Type is comprised of a Type that specifies that the command is used to operate a selected item.

15. The computer program as in claim 5, where the command Type is comprised of a Type that specifies that the command is used to create an item.

16. The computer program as in claim 5, where the command Type is comprised of a Type that specifies that the command is used to return a user to a logically previous screen of a UI display.

17. The computer program as in claim 5, where the command Type is comprised of a Type that specifies that the command is used to exit an associated application.

18. The computer program as in claim 5, where the command Type is comprised of a Type that specifies that the command is used to stop a currently running process or operation.

19. The computer program as in claim 5, where the command Type is comprised of a Type that specifies that the command is used to request help.

20. The computer program as in claim 5, where the command Type is comprised of a Type that specifies that the command has an undefined command type.

21. The computer program as in claim 1, where the command placement manager is comprised of one of a command structure or a modified command structure, a command UI and a supercontext.

22. The computer program as in claim 21, where the command UI represents at least one of soft controls and physical controls.

23. The computer program as in claim 21, where the supercontext comprises a context.

24. The computer program as in claim 21, where the command structure defines a hierarchy of commands.

25. The computer program as in claim 22, where the command UI is associated with command placement rules that are responsive to the device configuration.

26. The computer program as in claim 24, where the command structure is comprised of a prioritized command placement list that comprises placement hints each comprised of a command ID and the placement hints in priority order.

27. The computer program as in claim 26, where the command placement manager places commands on the UI according to placement list priority subject to priorities associated with a placement rule list that comprises part of the device configuration.

28. The computer program as in claim 1, where the device is comprised of a wireless communication device.

29. A device comprising a user interface (UI) comprised of a display and a user input comprised of at least one control, a data processor for running at least one application, and a UI command placement manager responsive to an instance of a UI command specification, comprised of a prioritized list of commands, to assign said at least one control to a command in accordance with information defining a device configuration.

30. The device as in claim 29, where a command comprises command properties comprised of an ID property that uniquely identifies the command, a Type property that is descriptive of an intent of the command, and a Labels property that is descriptive of a command name to be displayed on the display.

31. The device as in claim 30, where the command property is further comprised of at least one of a Sub-labels property that is descriptive of another version of the command name used by the command placement manager when the command is placed in a group that has a title; a Graphics property that is descriptive of a graphical representation of the command; and a Shortcut property that defines a mechanism for a user to initiate the command by a shortcut.

32. The device as in claim 30, where the command Type property is comprised of at least one of a Type that specifies that the command is used to provide a positive response; a Type that specifies that the command is used to provide a negative response; a Type that specifies that the command is used for opening a selected item; a Type that specifies that the command is used to destroy data; a Type that specifies that the command is used to operate a selected item a Type that specifies that the command is used to create an item; a Type that specifies that the command is used to return a user to a logically previous screen of a UI display; a Type that specifies that the command is used to exit an associated application a Type that specifies that the command is used to stop a currently running process or operation; and a Type that specifies that the command is used to request help.

33. The device as in claim 29, where the command placement manager is comprised of one of a command structure or a modified command structure comprised of a hierarchy of commands, a command UI that represents at least one of soft controls and physical controls, and a supercontext that comprises a context.

34. The device as in claim 33, where the command UI is associated with command placement rules that are responsive to the device configuration, and where the command structure is comprised of a prioritized command placement list that comprises placement hints each comprised of a command ID and the placement hints in priority order.

35. The device as in claim 34, where the command placement manager places commands on the UI according to placement list priority subject to priorities associated with a placement rule list.

36. The device as in claim 29, where the device is comprised of a wireless communication transceiver.

37. A method to operate a user interface (UI), comprising:
providing a UI-related prioritized command specification that is associated with an application; and
when the application is executed, mapping individual UI commands from the command specification to UI resources based on at least information conveyed by the commands, a context descriptive of a UI state of the application, and on information describing a configuration of a device that comprises the UI.

38. A method as in claim 37, where the UI resources comprise at least one of a soft button set, a hard button set, a touch button set, a toolbar and a menu.

39. A user interface (UI) manager, comprising means, responsive to a prioritized command specification that is associated with an application, for mapping individual UI commands from the command specification to UI resources based on at least information conveyed by the commands, a context descriptive of a UI state of the application, and on information describing a configuration of a device that comprises the UI, where a command comprises command properties comprised of at least an ID property that uniquely identifies the command and a Type property that is descriptive of an intent of the command.

40. A UI manager as in claim 39, where the UI resources comprise at least one of a soft button set, a hard button set, a touch button set, a toolbar and a menu, and where said UI manager is embodied in a device comprising communication means.
